(19) United States
(12) Patent Application Publication
(10) Pub. No.: US 2009/0272439 A1
(43) Pub. Date: Nov. 5, 2009

(54) MAXIMUM OPERATING PRESSURE CONTROL FOR SYSTEMS WITH FLOAT VALVE METERING DEVICES

(76) Inventor: Steven James Holden, Manlius, NY (US)

Correspondence Address: CARLSON, GASKEY & OLDS, P.C., 400 WEST MAPLE ROAD, SUITE 350, BIRMINGHAM, MI, 48009, US

(21) Appl. No.: 11/909,081

(22) PCT Filed: Jun. 2, 2005
(86) PCT No.: PCT/US05/19306

§ 371 Date: Sep. 19, 2007

(51) Int. Cl. F17D 3/00; F25B 43/00; F25B 39/04; F16K 31/18; F16K 21/00

(52) U.S. Cl. 137/14; 62/468; 62/509; 137/409; 137/613

(57) ABSTRACT

A chiller system (10) includes a compressor (12), a condenser (14), a cooler (20), a bubbler tube (22) and a float valve (18) within the condenser (14). A solenoid valve (26) is disposed within the bubbler tube (22) and is adapted to selectively open and close the float valve (18) such that a refrigerant flow to the cooler (20) is throttled. The throttled refrigerant flow results in a reduction in system pressure which further results in a higher viscosity oil delivery to the compressor (12) by an oil management system (30).

### BACKGROUND OF THE INVENTION

The present invention relates to chiller systems, and more particularly to a compressor based chiller system that includes a float valve to control refrigerant flow through the chiller system, wherein the float valve is selectively controlled by a solenoid valve during certain system operating conditions.

Compressor based chiller systems used to cool vast interior spaces such as airport terminals, shopping malls and office towers are known. Typically, these types of chiller systems have a closed circuit refrigerant system, which includes a compressor, a condenser, an evaporator or cooler, and an oil management system. High pressure refrigerant gas is delivered from the compressor to the condenser where the refrigerant gas is cooled and condensed to the liquid state. In many applications, the condenser includes a float valve for providing a liquid seal between the condenser and the cooler and for controlling the refrigerant flow to the cooler. A constant supply of gas is delivered under the float valve via a bubbler tube tapped off of a compressor discharge line to provide a buoyancy required to lift and open the float valve. The float valve closes when the chiller system is shut down to prevent refrigerant flow from the condenser to the cooler. The liquid refrigerant is delivered to the cooler where the refrigerant is further vaporized and returned to the compressor for recompression and delivery to the condenser in a continuous process. An oil management system provides lubricant to bearings and other running surfaces of the compressor to ensure the efficient operation of the chiller system. A water loop carries water that is chilled by the refrigerant system through an interior space to cool the air within the space.

Some chiller systems may be required to start-up with high temperatures in the water loop. For example, a chiller system in a large office building may be reset for the weekend. During the time the chiller system is shut off, the temperature of the water within the water loop may increase to a high temperature as a result of extreme exterior heat (such as temperatures experienced during the summer months or as experienced at locations with a warm climate). Upon restarting the chiller system in anticipation of the return of the occupants to the office building after the weekend, the chiller system is required to return high volumes of water in the water loop to a temperature sufficient to cool the air within the building. As the chiller system increases its output to achieve this cooling need, the pressure of the oil stored within the oil management system increases. The increase in pressure may result in a reduction in the viscosity of the oil delivered to the compressor for lubrication. Disadvantageously, the reduction in oil viscosity results in improper lubrication of the compressor components and the possibility of compressor failure.

Typically, the float valve includes a plurality of orifice slots that define a flow area to communicate refrigerant from the condenser to the cooler. The bubbler tube provides the buoyancy necessary to displace a stopper piece that prohibits the refrigerant from exiting through the orifice slots. Depending upon the level of refrigerant within the condenser, the orifice slots are either fully open or fully closed. Because the float valve is a discrete device that is either fully open or fully closed, the cooler may receive too much refrigerant or not enough refrigerant where large or small operating pressure differentials exist between the condenser and the cooler. The pressure differentials are the result of differences between ambient temperatures and interior building temperatures. Disadvantageously, these small and large operating pressure differentials result in poor refrigerant distribution between the condenser and the cooler. The poor refrigerant distribution may cause a loss in the chiller system operating efficiency.

Accordingly, it is desirable to provide a chiller system that is efficient and that provides for the selective control of the chiller system operating pressure during situations in addition to the shut down of the chiller system.

### SUMMARY OF THE INVENTION

A chiller system according to the present invention provides a controlled refrigerant flow through the chiller system.

The chiller system includes a compressor, a condenser, a cooler, bubbler tubes and a float valve within the condenser. The bubbler tubes communicate a gas from a compressor discharge line under the float valve to provide a buoyancy necessary to lift and open the float valve. A solenoid valve is disposed within the bubbler tubes and is modulated to a closed position in response to a pre-defined condition by a controller. Once the solenoid valve is commanded to a closed position, the float valve loses buoyancy and closes resulting in a throttled refrigerant flow to the cooler. The throttled refrigerant flow results in a reduction in system pressure, which further results in a higher viscosity oil delivery to the compressor by an oil management system.

The chiller system according to the present invention provides an efficient refrigerant flow and provides for the selective control of the chiller system operating pressure.

### BRIEF DESCRIPTION OF THE DRAWINGS

The various features and advantages of this invention will become apparent to those skilled in the art form the following detailed description of the currently preferred embodiment. The drawings that accompany the detailed description can be briefly described as follows:

FIG. 1 illustrates a schematic representation of a chiller system according to the present invention;

FIG. 2 illustrates a schematic representation of the chiller system according to the present invention including a float valve in an open position; and

FIG. 3 illustrates a schematic representation of the chiller system according to the present invention including the float valve in a closed position.

### DETAILED DESCRIPTION OF THE PREFERRED EMBODIMENTS

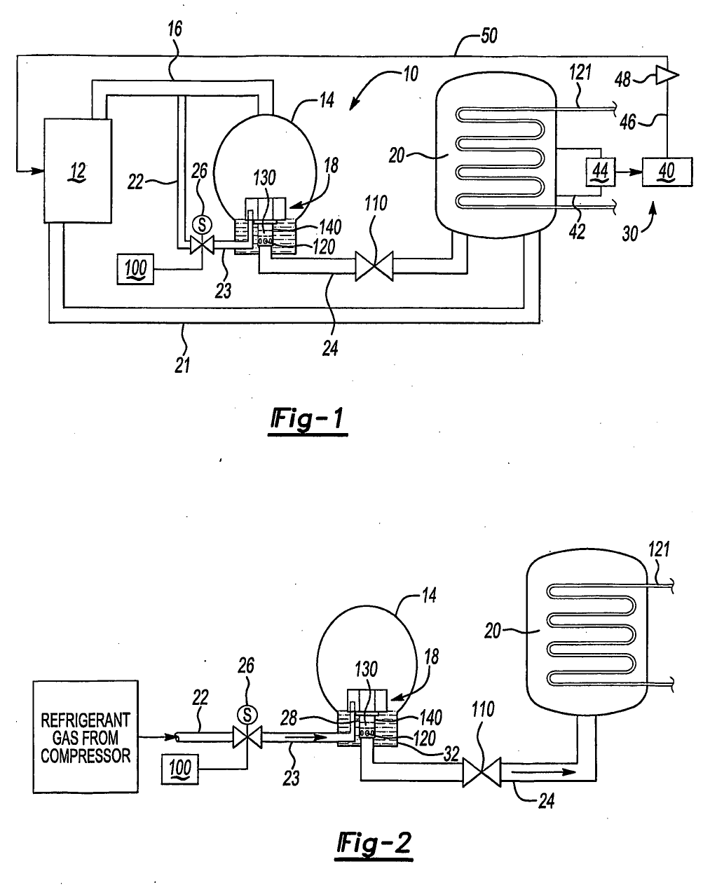

Referring to FIG. 1, an example chiller system 10 is illustrated. The chiller system 10 is a closed loop refrigerant system that includes a compressor 12 that communicates a high pressure refrigerant gas to a condenser 14. The compressor 12 may be a variable speed screw type compressor. It should be understood that other types of compressors are within the contemplation of this invention. The refrigerant gas is communicated to the condenser 14 via a discharge line 16. Upon entering the condenser 14, the refrigerant gas is cooled and condensed. The refrigerant is then delivered through an expansion device 110 and to a cooler 20. The refrigerant is evaporated in the cooler 20 into a low pressure refrigerant gas and returned to the compressor 12 for recompression and delivery to the condenser 14 in a continuous process. A suction line 21 delivers the vaporized refrigerant from the cooler 20 to the compressor 12.

A chilled water loop 121 is associated with the cooler 20 and is piped throughout an interior space. The chilled water loop 121 is a separate loop from the closed loop refrigerant system of the chiller system 10. The cooler 20 absorbs heat from water circulating within the chilled water loop 121. The water circulates through the chilled water loop 121 to cool the air within an interior space.

The condenser 14 preferably includes a float valve 18 for controlling the flow of the refrigerant from the condenser 14 to the cooler 20. The float valve 18 also provides a liquid seal between the condenser 14 and the cooler 20. The expansion device 110 may be integral to the float valve 18. A bubbler tube 22 is tapped off of the discharge line 16 and selectively supplies a refrigerant gas under the float valve 18 through a second bubbler tube 23. The refrigerant gas supplied under the float valve 18 via the bubbler tubes 22 and 23 provides a buoyancy required to lift and open the float valve 18 such that refrigerant may be delivered to the cooler 20. The refrigerant is delivered via a line 24 that connects the condenser 14 to the cooler 20. Typically, the line 24 carries a two-phase refrigerant. During normal operation of the chiller system 10, such as non-start up situations, the float valve 18 receives a constant supply of refrigerant gas from the bubbler tube 23 to remain in an open valve position.

A solenoid valve 26 is positioned between the bubbler tubes 22 and 23. It should be understood that the solenoid valve 26 may be utilized within any refrigerant system that includes a float valve. The solenoid valve 26 may be modulated by a controller 100 to modulate refrigerant flow to the cooler 20, as is further discussed below. The controller 100 may be any suitable microcontroller, microprocessor, computer or the like that would occur to one skilled in the art.

An oil management system 30 provides the running components within the compressor 12 with proper lubrication as is known. Preferably, the oil management system is provided on the low side of the chiller system 10, or near the cooler 20. The lubricant, such as oil, that is delivered to the compressor 12 is eventually mixed with refrigerant such that the refrigerant delivered from the condenser 14 to the cooler 20 includes a high quantity of oil. The refrigerant must be removed from the oil to increase the viscosity of the oil and make it more useful in lubricating the running components within the compressor 12.

Generally, the oil management system 30 includes a lubricant supply line 42 that delivers the refrigerant/oil mixture within the cooler 20 to a vaporizer 44. The vaporizer 44 is a heat exchanger containing elements that physically separate the hot refrigerant from the refrigerant/oil mixture. Once separated, the refrigerant is delivered back to the cooler 20 and the oil is delivered to an oil sump 40. From the oil sump 40, the oil passes through another lubricant supply line 46 to an oil pump 48, and through yet another lubricant supply line 50 back to the compressor 12 for lubrication of the running components.

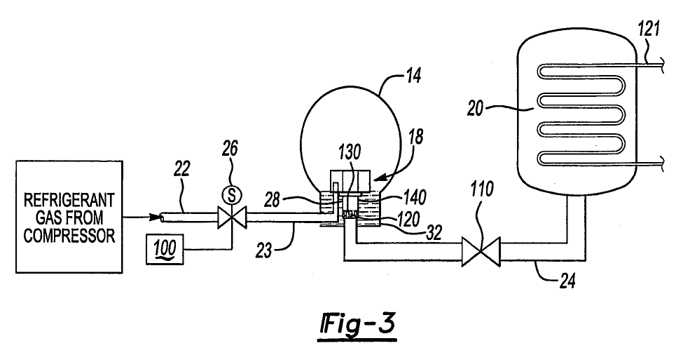

It is known by those with skill in the art that refrigerant/oil mixtures at low pressures are generally at higher viscosity than refrigerant/oil mixtures at high pressures. The solenoid valve 26 may be modulated to a closed position (See FIG. 3) to throttle the amount of refrigerant permitted to flow to the cooler 20 from the condenser 14 in response to the start-up of the chiller system 10 in instances where the temperature of the water in the chilled water loop 121 is high. The reduced flow rate of the refrigerant (relative to the temperature of the water within the chilled water loop 121) causes a pressure decrease within the cooler 20. As a result, the pressure of the oil stored within the oil sump 40 is likewise reduced. Therefore, a higher viscosity oil is delivered to the compressor 12 for lubrication.

Referring to FIG. 2, the float valve 18 is shown in an open position. The float valve 18 includes a plurality of orifice slots 120. The orifice slots 120 define a flow area for the refrigerant to enter line 24 and flow to the cooler 20. A stopper piece 130 is received within a stem 140 of the float valve 18 and is moveable within the stem 140 to open and close the flow area defined by the orifice slots 120. In this example, the solenoid valve 26 has been modulated to an open valve position by the controller 100. Therefore, the refrigerant gas from the bubbler tube 23 is permitted to enter the condenser 14 and provide the buoyancy necessary to float the stopper piece 130 and open the flow area defined by the orifice slots 120 of the float valve 18. In the open position, a steady supply of refrigerant from a liquid level 32 within the condenser 14 is freely communicated to the cooler 20. The float valve 18 remains in an open valve position during normal operation (such as non-start up situations) of the chiller system 10.

Referring to FIG. 3, the float valve 18 is illustrated in a closed position. In the illustrated example, the solenoid valve 26 is modulated to a closed valve position by the controller 100. Preferably, the solenoid valve 26 is modulated to a closed position in response to the start-up of the chiller system 10. It should be understood that the solenoid valve 26 may be selectively modulated to a closed position by the controller 100 in other situations such as where high pressure differentiations exist during operation (such that too much liquid refrigerant is delivered to the cooler 20) between the condenser 14 and the cooler 20.

As the solenoid valve 26 is closed, the refrigerant gas from the bubbler tube 22 is prevented from entering the condenser 14. Therefore, the float valve 18 does not receive the buoyancy necessary to float the stopper piece 130 of the float valve 18. As a result, the refrigerant from the liquid level 32 is prevented from being communicated through the orifice slots 120 to the cooler 20. The throttled flow rate to the cooler 20 has the desired effect of controlling the refrigerant levels in the cooler 20 thereby reducing the operating pressure within the cooler 20.

The present invention improves upon the prior art by utilizing the solenoid valve 26 to selectively open and close the float valve 18 in situations where the refrigerant operating pressures become too high, such as during start-up of the chiller system 10. Thus, a higher viscosity oil may be delivered by the oil management system 30 to the compressor 12 as required.

The present invention further provides for the active control of the refrigerant distribution within the cooler 20. Specifically, the solenoid valve 26 can be modulated to open and close the float valve 18 to control the amount of refrigerant that is permitted to enter the cooler 20. Control of the refrigerant distribution within the cooler 20 results in the controlled flow of the refrigerant/oil mixture into the lubricant supply line 42 and the vaporizer 44. The controlled flow of the refrigerant/oil mixture into the vaporizer 44 results in a more consistent oil viscosity delivery to the compressor 12, which further results in a more efficient chiller system 10. Although it has been disclosed that the bubbler tube 22 is tapped off of the discharge line 16 to supply a refrigerant gas under the float valve 18, other sources including sources from within the compressor 12 may be tapped off of by the bubbler tube 22 to communicate the refrigerant gas under the float valve 18.

The foregoing description shall be interpreted as illustrative and not in any limiting sense. A worker of ordinary skill in the art would recognize that certain modifications would come within the scope of this invention. For that reason, the following claims should be studied to determine the true scope and content of this invention.

We claim:

1. A refrigerant system comprising:
a compressor having a discharge line;
a condenser communicating with said discharge line and having a float valve;
a bubbler tube communicating a refrigerant to said float valve;
a cooler receiving a refrigerant flow from said condenser, said float valve controlling the refrigerant flow between said cooler and said condenser; and
a solenoid valve disposed within said bubbler tube that selectively closes said float valve such that said refrigerant flow to said cooler is throttled.

2. The system as recited in claim 1, further comprising a line connecting said condenser to said cooler wherein at least a portion of said line is disposed adjacent to said float valve.

3. The system as recited in claim 2, wherein said float valve includes a plurality of slots and a stopper piece.

4. The system as recited in claim 3, wherein said refrigerant from said bubbler tube provides a buoyancy necessary to float said stopper piece and allow said refrigerant to pass through said plurality of slots and enter said line when said solenoid valve is in an open position.

5. The system as recited in claim 4, further comprising a controller operable to open and close said solenoid valve.

6. The system as recited in claim 5, wherein said controller commands said solenoid valve to a closed position in response to a pre-defined condition such that said refrigerant flow to said cooler is throttled.

7. The system as recited in claim 6, wherein said pre-defined condition includes a start-up of the system.

8. The system as recited in claim 6, wherein said pre-defined condition includes a high pressure differential between said condenser and said cooler.

9. The system as recited in claim 6, wherein said refrigerant from said bubbler tube is prevented from opening said float valve in response to said solenoid valve being in said closed position.

10. The system as recited in claim 9, further comprising an oil sump, said cooler and said oil sump each having a reduced pressure in response to said solenoid valve being in said closed position.

11. The system as recited in claim 10, further comprising an oil line in communication with said oil sump of said cooler that provides said compressor with oil.

12. The system as recited in claim 1, wherein said cooler is associated with a water line, said cooler cooling water that circulates within said water line.

13. The system as recited in claim 1, wherein said refrigerant is compressed within said compressor.

14. A refrigerant system comprising:
a compressor having a discharge line;
a condenser communicating with said discharge line and having a float valve;
a bubbler tube communicating a refrigerant to said float valve;
a cooler receiving a refrigerant flow from said condenser, said float valve controlling said refrigerant flow between said cooler and said condenser;
a line connecting said condenser to said cooler with at least a portion of said line disposed adjacent to said float valve, wherein said refrigerant from said bubbler tube provides a buoyancy necessary to open said float valve;
a water line associated with said cooler, said cooler cooling water circulating within said water line; and
a solenoid valve disposed within said bubbler tube that selectively closes said float valve such that said refrigerant flow to said cooler is throttled.

15. The system as recited in claim 14, wherein said refrigerant gas is compressed in said compressor.

16. A method of controlling the operating pressure in a chiller system, comprising:
(1) providing a solenoid valve in a bubbler tube; and
(2) selectively activating the solenoid valve to a closed position in response to a predetermined condition such that a refrigerant flow is throttled.

17. The method as recited in claim 16, wherein said step (2) comprises:
closing the solenoid valve to prevent a refrigerant from floating a float valve.

18. The method as recited in claim 16, wherein said step (2) comprises:
defining the predetermined condition to include start-up of the chiller system.

19. The method as recited in claim 16, wherein said step (2) comprises:
defining the predetermined condition to include a high pressure differential between a condenser and a cooler.

20. The method as recited in claim 17, comprising the step of:
(3) selectively activating the solenoid valve to an open position to allow the refrigerant to float the float valve.
